(19) United States
(12) Patent Application Publication
(10) Pub. No.: US 2005/0121819 A1
(43) Pub. Date: Jun. 9, 2005

(54) Laminate oleophilic reformative clay and a method of production for the same, the material and method of production of ABS nano-metric composite material produced by the same

(75) Inventors: Jui-Ming Yeh, Chung Li City (TW); Chao-Cheng Huang, Chung Li City (TW); Chi-Lun Chen, Chung Li City (TW); Shir-Joe Liou, Chung Li City (TW); Te-Fong Chan, Taipei (TW); Yuan-Hsiang Yu, Taipei (TW); Jui-Ting Hsu, Taipei (TW); Chihohe Kuo, Taipei (TW); Yu-An Li, Taipei (TW); Kuei-Wen Cheng, Taipei (TW)

Correspondence Address: TROXELL LAW OFFICE PLLC, SUITE 1404, 5205 LEESBURG PIKE, FALLS CHURCH, VA, 22041, US

(73) Assignee: TECO NANOTECH CO., LTD.

(21) Appl. No.: 10/729,978

(22) Filed: Dec. 9, 2003

(51) Int. Cl. C04B 33/00; C04B 33/02; C04B 33/04

(52) U.S. Cl. 264/141; 264/140; 106/486; 106/487; 501/148; 501/146

(57) ABSTRACT

A laminate oleophilic reformative clay and a method of production for the same are described, and a material and method of production for ABS nano-metric composite material produced by the same are also described. The ABS nano-metric composite material is waterproof for a self-cleaning ability and has enhanced strength. The cost to produce the ABS nano-metric composite material is also reasonable. The ABS nano-metric composite material is made of ABS substrate formed from ABS material and laminate oleophilic reformative clay uniformly distributed in the ABS substrate.

### FIELD OF THE INVENTION

The present invention relates to a technique to produce a specific nano-metric composite material by kneading laminate oleophilic reformative clay with ABS resin. By the way of reforming the inorganic clay to have the oleophilic functional group, the compatibility between the said reformed clay and the organic ABS polymer is improved. The oleophilic reformative clay can open gaps between the laminate structures of the clay to allow the small ABS molecule particle to combine with the laminate structure of the clay. Then the kneading process of ABS and the reformative clay completely mixes the two materials. The kneading process does not require solvent, thus saving the cost of solvent and sparing the environment. The ABS nano-metric composite material (also called nanocomposite) is self-cleaning, has improved strength, is thermally stable, and cheap to add the reformed clay for mass production. The present invention relates to the material content and the method of production of the self-cleaning ABS nano-metric composite material, and particularly to use of the ABS (Acrylonitrile-Butadiene-Styrene Copolymer) to produce an improved material.

### BACKGROUND OF THE INVENTION

Current polymers usually are made with inorganic materials, such as, for example, such as glass fiber, clay, or black carbon powder, as co-filling material or for strength enhancement material. The purpose of these inorganic materials is to reduce the production cost or to enhance the physical property or strength. Thus a composite material is produced for every application. The property of the produced polymer material is determined by the spreading ability of the added inorganic material. In the conventional technique, a mechanical spreading method is applied and its effect is limited. The spreading ability of mechanical method can only spread the inorganic material to 10⁻⁶ meters. But recent research in nano-metric technique indicates that the clay material in the polymer material can be spread to 1-9 meters, thus generating nano-metric composite material.

When the inorganic material has a pellet diameter of 1 nm-100 nm spreading in the composite material, the physical property of the nano-metric particles are changed, to the point where quantum mechanics rather than traditional mechanics are appropriate to describe the action of the nano-metric particles. As a result, the properties of nano-metric material, such as a tiny diameter, a laminate strength enhancement structure, and ionic bonding, are useful in many applications. The purpose of nano-metric material is to be, for example, light weight, high in strength, high in rigidity, high in thermo-durability, low in water absorption, low in gas leakage, and recyclable. Thus these kinds of nano-metric material can be widely applied in, for example, coating materials, corrosion prevention, communications, optical materials, electrical components, biomedical devices and the environment.

From the above description of inorganic co-filling material, the clay can provide mechanical strength or resistance to chemical compounds. In addition, the clay is cheap and it has been widely used in reforming research. The clay is generally used in laminate structures with a laminate thickness of 1 nm. The surface inside the clay laminate has the metal ions, such as Na⁺, K⁺, to be exchanged. The laminate is connected by van der Waals forces and the ionic bonds between the metal ions. The special exchangeable property of the metal ions in the clay can be reformed by the special functional group to form a reformed clay with special functional group. Thus the clay property can be improved or enhanced by the reforming action. In addition, if a kneading technique is employed with the nano-metric material with the polymer, some kinds of nano-metric composite material can be formed. Research trends were set by the disclosure of the nano-metric composite of Nylon 6/Montmorillonite (one kind of clay) in 1990 by TOYOTA Central R&D LAB, Inc. In recent years, many kinds of ABS nano-metric composite materials have been proposed. Form these methods of production of ABS nano-metric composite materials, we can conclude the first step is to reform the anion functional group of the clay together with expanding the laminate distance of the clay, so that polymer molecules of nano-metric size can enter the gaps between the laminates for chemical reaction with the polymer. Then the material property can meet each requirement by the special reformation functional group. The present invention is to knead a laminate oleophilic reformative clay into the ABS resin to form a ABS nano-metric composite material. By reforming the clay with the oleophilic functional group, compatibility with the ABS resin can be improved. The kneading action and the reformation of clay are also helpful for the laminate expansion of the clay by allowing the ABS polymer molecule to enter the laminate of the clay. Then a heating for melting and kneading process can be applied to mix the ABS and reformed clay. The present invention does not need solvent. This feature obviously reduces the producing cost and protects the environment. The nano-metric composite material produced from the present invention has a self-cleaning property because it its waterproof, a higher mechanical strength, and a better thermo-stability. Thus a cheap material for mass production is generated for industry.

### SUMMARY OF THE INVENTION

The main purpose of the present invention is to provide a new ABS nano-metric composite material that is, for example, self-cleaning because it its waterproof, has higher mechanical strength, and is thermally stable.

Another purpose of the present invention is to provide a new ABS nano-metric composite material that does not need solvent in the manufacturing process thereof. The material is thus cheaper than that produced by the conventional method.

A further purpose of the present invention is to provide a convenient method for making a new ABS nano-metric composite material that is suitable for mass production.

In order to attain the above purposes, the present invention proposes a method of production that kneads oleophilic reformative clay with the ABS resin to form a new ABS nano-metric composite material. Through the process of reformation to the inorganic clay by the oleophilic functional group, the compatibility of the ABS resin is improved in the kneading process. In addition the reformative clay can have a wider gap between the laminate to allow the ABS molecule polymer to enter into the gap for a tight connection. Then a heating for melting and kneading process can be applied to mix the ABS and the reformed clay. The present invention does not use solvent, which obviously is cheaper and sparing of the environment. The nano-metric composite material produced from the present invention is self-cleaning property because it is waterproof, has the higher mechanical strength, and is more thermally stable. A cheap material for mass production is thus generated for industry.

The present invention comprises a laminate oleophilic reformative clay. The laminate oleophilic reformative clay comprises a laminate area having the laminate structure with a plurality of oleophilic functional groups installed in the gaps between laminates and combined into the laminates by chemical bonds. The gap distance between the laminates are in a predetermined range for receiving the oleophilic functional groups. The clay is reformed by installation of the oleophilic functional groups in the laminates.

The present invention further comprises a method of production for laminate oleophilic reformative clay, comprising the steps of: (1) using water solution to expand lubricatively the laminates of smectite clay; (2) blending organic alkyl ammonium halogenated salt solution, as the reformative chemical, with the water solution of smectite clay while agitating to produce a chemical reaction; (3) after a predetermined period of blending agitation, filtering the solution to obtain a deposited sediment; (4) washing the sediment with water and then drying the sediment to obtain the oleophilic reformative clay.

The present invention further comprises an ABS nano-metric composite material, which comprises an amount of ABS substrate and a kind of laminate oleophilic reformative clay. The molecule of the ABS substrate extend into the laminate structure to connect tightly to the laminate oleophilic reformative clay. The laminate oleophilic reformative clay has a weight ratio of about 3-7% to be contained in the ABS nano-metric composite material.

The present invention further comprises a method of production of ABS nano-metric composite material, comprising the steps of: (1) dry blending a predetermined amount of ABS resin with the laminate oleophilic reformative clay with an about 3-7 percentage by weight; (2) using a kneading machine to force the ABS resin and the laminate oleophilic reformative clay to be mixed under a predetermined shear force to press the laminate oleophilic reformative clay to spread uniformly into the ABS resin, the kneading temperature being set in a range from about 180° C. to 250° C.; (3) after kneading, using a cutting tool to produce a plurality of blended pellets, the primary degree of ABS composite material being produced; (4) kneading the primary degree of ABS composite pellets again for greater uniformity; and (5) again using the cutting tool to produce a plurality of secondary blended pellets, the final product of ABS nano-metric composite material. The first and the second kneading process use an air extraction device to exhaust air while kneading to avoid air bubbles in the pellets.

### BRIEF DESCRIPTION OF DRAWING

The various objects and advantages of the present invention will be more readily understood from the following detailed description when read in conjunction with the appended drawing, in which:

FIG. 1 shows a schematic view of the structure of conventional laminate oleophilic reformative clay and reformation process;

FIG. 2 shows a schematic view of the conventional concept for ABS nano-metric composite material; and

FIG. 3 shows a schematic view of the kneading process of the present invention.

### DETAILED DESCRIPTION OF THE INVENTION

The present invention provides the ABS nano-metric composite material, which comprises a polymer substrate for nano-material including the ABS, and a kind of laminate oleophilic reformative clay, formed by kneading a material with uniformly spread mixing. In particular, the present invention mixes ABS resin with a greater amount and the laminate oleophilic reformative clay with an about 3-7 weight percentage.

The raw material of the clay of the laminate oleophilic reformative clay is smectite clay. The exchanging equivalent weight of the anion thereof is about 60-120 meq/100 g for the reformation of the oleophilic functional group. In particular, montmorillonite is suitable because its equivalent weight of the anion is about 90-100 meq/100 g. A water solution is used to expand lubricatively laminates of smectite clay. Then organic alkyl ammonium halogenated salt solution as the reformative chemical is blended with the water solution of smectite clay under agitation to produce a chemical reaction. The organic alkyl ammonium halogenated salt is preferably C₁₉H₄₂NBr (Hexadecytrimethyl ammonium bromide) as the reformative chemical. After a predetermined period of time of blending with agitation, the solution is filtered and a deposited sediment is obtained. The sediment is washed with water and then dried to obtain the oleophilic reformative clay. In addition, after drying, the sediment can be ground to a particle diameter of 10⁻⁶ m for practical application.

The ABS nano-metric composite material of the present invention is produced by dry blending a predetermined amount of ABS resin with the laminate oleophilic reformative clay in an about 3-7 weight percentage. Then a twin screw kneading machine mixes the ABS resin and the laminate oleophilic reformative clay under a predetermined shear force to spread the laminate oleophilic reformative clay uniformly in the ABS resin, the kneading temperature being set in a range of about 180° C. to 250° C. and the preferred range being from about 190° C. to 210° C. The kneading process uses an air extraction device to exhaust air during the kneading process and avoid air bubbles in the kneaded pellets. After kneading, a cutting tool is used to produce a plurality of blended pellets, the primary degree of ABS composite material being produced. Then the primary degree of ABS composite pellets is kneaded again for further uniformity. The cutting tool is again used to produce a plurality of secondary blended pellets, the final product of ABS nano-metric composite material being produced.

A preferred embodiment, particularly for laminate oleophilic reformative clay, is described as follows:

The practical embodiment of present invention for the laminate oleophilic reformative clay uses raw material from the Pai Kong Nano Technology Co., Ltd., inorganic laminate Montmorillonite clay PK-805 (equivalent weight of the anion being about 98 meq/100 g) being mixed into the water solvent in suspension with a weight ratio of about 25-40% to expand the clay lubricatively. Then C₁₉H₄₂NBr (Hexadecytrimethyl ammonium bromide) is prepared with a weight ratio of about 40-50% to the clay to be mixed as a water solvent, and is slowly added to the clay suspension solution and agitated for a long time. After agitation, the solution is filtered to obtain a sediment. The sediment is washed many times with distilled water and then dried at about 80° C. The dry sediment is ground in a ball grinding machine to a powder diameter of 10⁻⁶ m, thus producing laminate oleophilic reformative clay of present invention. The produced reformed clay can be analyzed by X-ray diffraction and compared to unreformed clay. Montmorillonite clay PK-805 was tested to obtain the data of the 2θ being 6.840 to infer the gap distance of laminate being 1.3 nm (from the formula of Prague), and the reformed clay of the present invention was tested to obtain the 2θ value as 3.850 to infer the gap distance of laminate being 2.3 nm for the obvious effect of the extension of gap distance.

Another preferred embodiment of the present invention is described for ABS nano-metric composite material, as follows. The raw material of the present invention, PA-717C ABS pellet from the Chi Mei Corporation, is mixed with the laminate oleophilic reformative clay in a weight ratio of about 3-7% by uniform dry blending. The blended mixture is kneaded in a twin screw kneading machine, the kneading temperature being set in a range of about 180° C. to 250° C. and the preferred range being about 190° C. to 210° C. An air extraction device exhausts air during the kneading process to avoid air bubbles in the kneaded pellets. After kneading, a cutting tool is used to produce a plurality of blended pellets, the primary degree of ABS composite material being produced. Then the primary degree of ABS composite pellets are kneaded again for further uniformity. The cutting tool is used again to produce a plurality of secondary blended pellets, the final product of ABS nano-metric composite material being produced. Analysis is performed by X-ray diffraction on the final ABS nano-metric composite material to obtain reference data for the laminate of reformed clay particles, indicating that the gate distance of the laminate is extended to about 3.1 nm. This confirms that the laminate of the reformed clay has been opened by the kneading process and distributed in the ABS substrate. In addition, thermogravimetric analysis and a differential scanning calorimeter are used to analyze the original pure ABS and the ABS nano-metric composite material of the present invention, and the transferring temperature of the said ABS nano-metric composite material of the present invention is about 103° C. to 106° C.; obviously higher when compared with the original transferring temperature of original pure ABS material of 97.3° C. Further, as an indicator of mechanical strength, a test piece of the ABS nano-metric composite material can be made (according to the ASTM D638 regulation) by injection molding. From the comparison of the mechanical strength of the ABS material to the ABS nano-metric composite material, the mechanical strength can be raised from 3.97 Kg/mm² (original ABS) to about 4.37 Kg/mm² (ABS of the present invention), an obvious increase of 10%. The dimensional stability of the original ABS is tested as 11.05 in elongation, while the ABS nano-metric composite material is tested as 5%, an obvious increase of 56.5% in elongation. The ABS nano-metric composite material can also be tested under the Sessile Drop Method for the water familiarity test to measure the static Contact Angle. The contact angle of the ABS nano-metric composite material is 84 degrees greater than the 79 degrees of the original ABS material, where a larger contact angle represents water unfamiliarity. We can note that the ABS nano-metric composite material has greater water unfamiliarity, which increases the self-cleaning ability thereof.

The present invention uses melting and blending to force the variation of lamination, being executed by the kneading processing of the laminate oleophilic reformative clay and the ABS resin, forcing the laminate oleophilic reformative clay to be uniformly distributed in the ABS to produce the special material of the present invention. The method does not need solvent, which is obviously cheaper. Various tests prove that the laminate oleophilic reformative clay has extended lamination and uniform distribution in the ABS resin. The new material of present invention has improved thermal and mechanical properties. The contact angle in the test proves the water unfamiliarity thereof is better than if the ABS and thus has a self-cleaning ability.

Reference is made to FIG. 2 to show the structure of the ABS nano-metric composite material 5, which comprises an amount of ABS substrate being formed by the ABS material 4 and a kind of laminate oleophilic reformative clay 3 with a laminate structure being uniformly distributed in the ABS substrate. As shown in the FIG. 2, the molecules of the ABS substrate extend into the laminate structure to connect tightly with the laminate oleophilic reformative clay 3. The laminate oleophilic reformative clay 3 is applied with a weight ratio of about 3-7% to be contained in the ABS nano-metric composite material 5. The laminate oleophilic reformative clay 3 is produced from the smectite clay reformed with the alkyl ammonium halogenated salt.

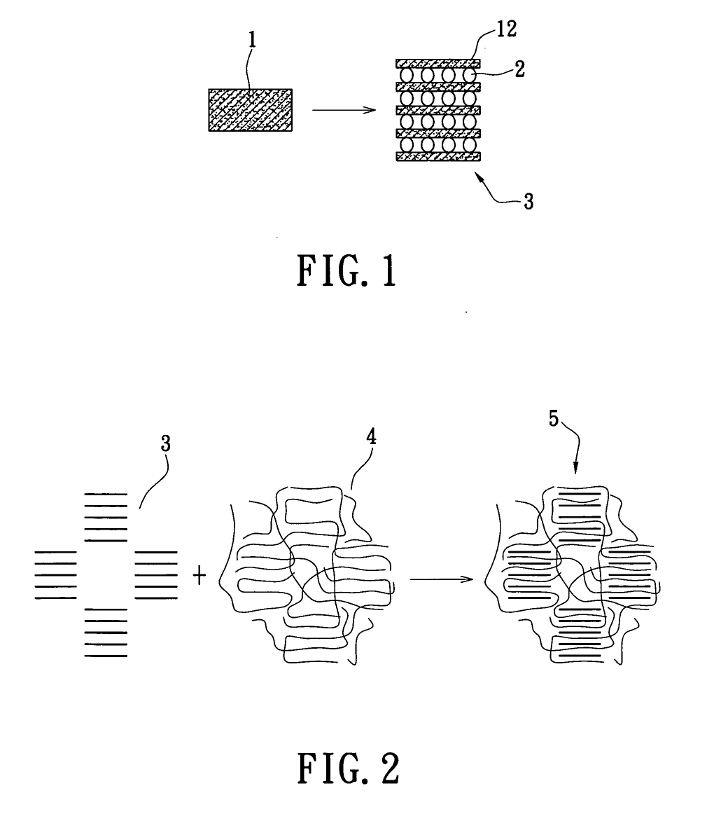

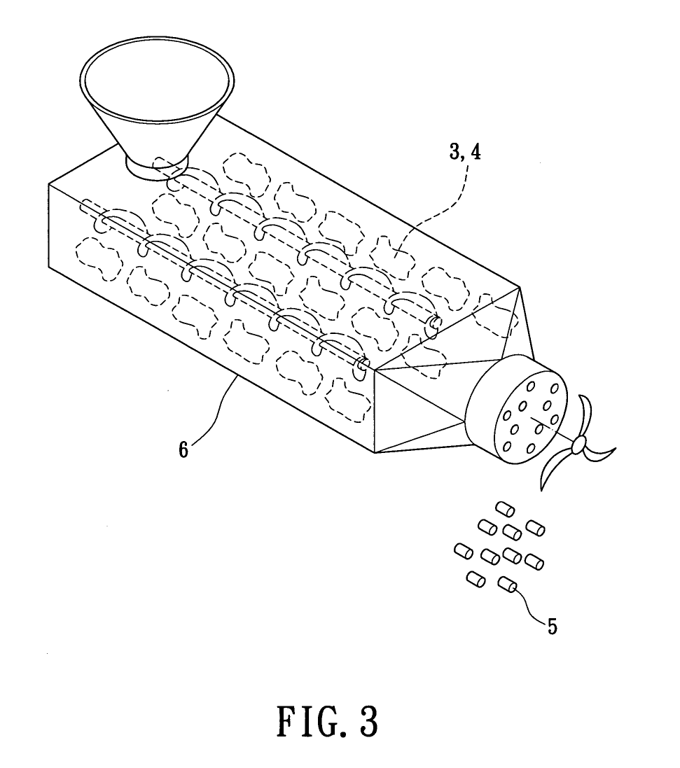

Reference is made to FIG. 3. The present invention comprises a method of production of ABS nano-metric composite material 5, comprising the steps of: (1) dry blending a predetermined amount of ABS resin with the laminate oleophilic reformative clay in an about 3-7 weight percentage; (2) mixing the ABS resin and the laminate oleophilic reformative clay in a kneading machine (the twin screw kneading machine 6 shown in FIG. 3) under a predetermined shear force to spread the laminate oleophilic reformative clay uniformly in the ABS resin, the kneading temperature being set in a range of about 180° C. to 250° C.; (3) using a cutting tool to produce a plurality of blended pellets, the primary degree of ABS composite material being produced; (4) kneading the primary degree of ABS composite pellets again for greater uniformity; and (5) using the cutting tool again to produce a plurality of secondary blended pellets, the final product of ABS nano-metric composite material being produced. An air extraction device is employed during the first and the second kneading processes to avoid air bubbles in the pellets. The kneading temperature is set in a range of about 190° C. to 210° C. for a better kneading effect. Reference is made to the FIG. 1. The ordinary clay 1 is a laminate structure while the present invention comprises a laminate oleophilic reformative clay 3, which comprises a laminate area 12 having the laminate structure, and a plurality of oleophilic functional groups 2 installed between the gap of laminates and combined into the laminates by chemical bonds. The gap distance between the laminates are in a predetermined range for receiving the oleophilic functional groups 2. Reformation of the clay is attained by installation of oleophilic functional groups in the laminates. The predetermined range of gap distance is from about 2.0 nm to 2.6 nm.

The present invention contains a method of production of laminate oleophilic reformative clay 3, comprising the steps of: (1) using the water solution to expand lubricatively the laminates of smectite clay; (2) blending organic alkyl ammonium halogenated salt solution as the reformative chemical with the water solution of smectite clay under agitation for chemical reaction; (3) after a predetermined period of time of blending under agitation, filtering the solution for a deposited sediment; (4) washing the sediment with water then drying the sediment to obtain the oleophilic reformative clay. The method can further comprise a step, after the drying of the sediment, of grinding the sediment to a particle diameter of 10⁻⁶ m for practical application. The organic alkyl ammonium halogenated salt is C₁₉H₄₂NBr (Hexadecytrimethyl ammonium bromide).

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

1. A laminate oleophilic reformative clay, comprising:
a laminate area having a laminate structure; and
a plurality of oleophilic functional groups installed between gaps of laminates, and combined into the laminates by chemical bonds;
wherein a gap distance between the laminates are in a predetermined range for receiving the oleophilic functional groups; and
whereby installation of the oleophilic functional groups in the laminates reforms the clay.

2. The laminate oleophilic reformative clay as claimed in claim 1, wherein the predetermined range for the gap distance is from about 2.0 nm to 2.6 nm.

3. A method of production for laminate oleophilic reformative clay, comprising the steps of:
(1) using a water solution to expand lubricatively laminates of smectite clay;
(2) blending organic alkyl ammonium halogenated salt solution, as the reformative chemical, with the water solution of smectite clay under agitation for chemical reaction;
(3) after a predetermined period of time of blending under agitation, filtering the water solution to obtain a deposited sediment;
(4) washing the deposited sediment with water then drying the deposited sediment to obtain the oleophilic reformative clay.

4. The method of production for laminate oleophilic reformative clay as claimed in claim 3, further comprising, after drying the deposited sediment, grinding the deposited sediment to a particle diameter of 10⁻⁶ m for practical application.

5. The method of production for laminate oleophilic reformative clay as claimed in claim 3, wherein the organic alkyl ammonium halogenated salt is C₁₉H₄₂NBr (Hexadecytrimethyl ammonium bromide).

6. An ABS nano-metric composite material, comprising:
an amount of ABS substrate; and
the laminate oleophilic reformative clay as claimed in claim 1;
wherein molecules of the ABS substrate extend into the laminate structure to connect tightly with the laminate oleophilic reformative clay; and
wherein the laminate oleophilic reformative clay is applied with a weight ratio of about 3-7% to be contained in the ABS nano-metric composite material.

7. The ABS nano-metric composite material as claimed in claim 6, wherein the laminate oleophilic reformative clay is produced by reforming smectite clay with alkyl ammonium halogenated salt.

8. A method of production for ABS nano-metric composite material, comprising the steps of:
(1) dry blending a predetermined amount of ABS resin and the laminate oleophilic reformative clay as claimed in claim 1 with a 3-7 weight percentage;
(2) mixing the ABS resin and the laminate oleophilic reformative clay in a kneading machine under a predetermined shear force to spread the laminate oleophilic reformative clay uniformly in the ABS resin, a kneading temperature being set in a range of about 180° C. to 250° C.;
(3) using a cutting tool to produce a plurality of blended pellets, a primary degree of ABS composite material being produced;
(4) kneading the primary degree of ABS composite pellets again for greater uniformity; and
(5) again using the cutting tool to produce a plurality of secondary blended pellets, a final product of ABS nano-metric composite material being produced; wherein an air extraction device is employed in the first and the second kneading processes to avoid air bubbles in the pellets.

9. The method of production for ABS nano-metric composite material as claimed in claim 8, wherein the kneading temperature is set in a range from about 190° C. to 210° C. for a better kneading effect.

10. The method of production for ABS nano-metric composite material as claimed in claim 8, wherein the laminate oleophilic reformative clay is smectite clay reformed with alkyl ammonium halogenated salt.
